(19) United States
(12) Patent Application Publication
(10) Pub. No.: US 2018/0274766 A1
(43) Pub. Date: Sep. 27, 2018

(54) Reusable/Re-Adherable Portable Lighting Assembly

(71) Applicant: Etai Weinstein, Conshohocken, PA (US)

(72) Inventor: Etai Weinstein, Conshohocken, PA (US)

(21) Appl. No.: 15/934,774

(22) Filed: Mar. 23, 2018

Related U.S. Application Data
(60) Provisional application No. 62/476,167, filed on Mar. 24, 2017.

(51) Int. Cl. F21V 21/08; F21V 23/04; F21V 23/06; F21V 21/02; F21V 21/096; F21S 9/02; F21L 4/08

(52) U.S. Cl. CPC F21V 21/0808; F21V 23/0414; F21V 23/0407; F21V 23/06; F21Y 2115/10; F21V 21/0832; F21V 21/0965; F21S 9/022; F21L 4/08; F21V 21/02

(57) ABSTRACT

A portable lighting assembly includes a base, having at least one translucent front side, a light, a battery, a switch, and a coupling member. The portable lighting assembly can be used for safety, recreation, entertainment, decoration, or any other purpose where illumination is desired. It can be used by emergency medical technicians, law enforcement officers, military personnel, mechanics, construction workers, plumbers, electricians, or others who require specific areas to be illuminated in the course of their work. It can also be used by those requiring illumination for visibility or safety in dim or nighttime conditions such as nighttime jogging, roadside emergencies, and deep sea diving. The portable lighting assembly includes a coupling member capable of re-attaching to objects such that the lighting assembly could be transferred from one object to another.

### CROSS-REFERENCE TO RELATED APPLICATION

This application claims priority to U.S. provisional application No. 62/476,167, filed Mar. 24, 2017, which is incorporated herein by reference in its entirety.

### BACKGROUND

Portable lighting assemblies are useful for providing a user with artificial light when needed, for example, at nighttime whether it be indoors or outdoors. Portable lighting assemblies could be used for a number of purposes including aiding the user to see in the dark as well as providing the user a means to be seen.

For the first stated purpose, i.e., aiding the user to see in the dark, portable lighting assemblies in the prior are typically take the form of a flashlight or headlamp. There are numerous disadvantages to these devices. A flashlight prevents the user from using both hands. A headlamp requires the user to wear the light on the head, typically illuminating only the direction the user is facing.

For the second stated purpose, i.e., providing a means to be seen, portable lighting devices in the prior art sometimes take on the form of a bulky lighting assembly, usually a flashing light, that is attached to the users belt or clothing. The flashing light is also uncomfortable because it is difficult to secure it to a stationary position while walking or running.

Another product typically used to provide a means to be seen in the dark is a reflective vest.

Often times neither of these options are desirable for when the device is in motion, such as when used while walking, jogging, running, cycling, climbing, while strolling with a baby carriage or shopping cart, or on pets. For example, with respect to the flashing light option, the bulkiness and unsecure flashing light is constantly moving with every stride. For the reflective vest, it is unattractive and requires the user to wear an extra layer clothing.

Another disadvantage in the portable lighting assemblies of the prior art is that they are not easily interchangeable. That is, it is time-consuming and cumbersome to replace the portable lighting assembly from one garment to another. It is also difficult to use the same portable lighting assembly on any part of the body and on any type of garment.

For home use, lighting assemblies of the prior art are not reusable. For example, a popular lighting assembly sold today includes adhesive for securing to a wall or an object. That lighting assembly, however, is not reusable because once removed from a first object, the object can become damaged and, more importantly, the adhesive is no longer functional and therefore, the lighting assembly cannot be re-attached to another object.

Furthermore, it is difficult if not impossible to install the portable lighting assemblies of the prior art on other objects of different shapes and sizes.

Therefore, a need exists for a more portable lighting assembly that can be used hands-free and placed on any surface while being easily replaceable and reusable.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The portable lighting assembly of the present invention solves the problems of the prior art and provides additional advantages. In general, the present invention includes any type of light with a coupling member for attaching the light to an object. More specifically, the portable lighting assembly of the present invention comprises a base, having at least one translucent front side, a light, a battery, a switch, and a coupling member.

The portable lighting assembly can be used for safety, recreation, entertainment, decoration, or any other purpose where illumination is desired. For example, it can be used by emergency medical technicians, law enforcement officers, military personnel, mechanics, construction workers, plumbers, electricians, or others who require specific areas to be illuminated in the course of their work. It can also be used by those requiring illumination for visibility or safety in dim or nighttime conditions such as nighttime jogging, roadside emergencies, and deep sea diving. Bright LED lights can be visible for up to half a mile, which can help users to be seen from a distance such as at sea or by fast-moving drivers to avoid hazards. The intuitive operation allows the portable lighting assembly to be used quickly and by anyone, including children, without instructions, which can be crucial in emergency situations. As such, the portable lighting assembly of the present invention allows a user to safely see and be seen.

In an embodiment of the present invention, a portable lighting assembly includes: a base having a front side and a rear side, wherein at least the front side is translucent; a lamp for generating light to pass through at least the translucent front side; a first power source; a switch for selectively electrically coupling the first power source to the lamp for illuminating the lamp; and a coupling member, connected to the base, for removably attaching the base to an object. The base is composed of a material selected from silicone, rubber, plastic, fabric, metal, a flexible material, and a non-flexible material. The translucent portion is colored. The translucent portion has a predetermined shape having at least one degree of opaqueness. A lining is mounted on a surface of at least one of the front side and the rear side for providing user comfort. The lining is cushioned for providing the user comfort. The base is composed of at least flexible translucent silicone that is water-resistant and weather-resistant and includes a lining to protect the lamp and the battery. The lamp is selected from a light-emitting diode (LED), a fluorescent light, and an incandescent light. The first power source is a battery. A battery compartment is included wherein the battery is replaceably mounted in the battery compartment. Alternatively, a port is included which is mounted in the base for being electrically coupled to a charging cable connected to an external second power source; and wherein the battery is electrically coupled to the port and is rechargeable from the external second power source. The lamp includes a plurality of lights. The switch controls at least one of an intensity of the lamp, a color of the lamp, a strobing function of the lamp, and a flashing function of the lamp. A timer is included to automatically turn the lamp on or off. The switch is a push button disposed at a top end of the base. The object is selected from a portion of a body of a user, an article of clothing worn by the user, and a piece of equipment used by the user. The coupling member is selected from a hook-or-loop fastener, a magnet, an adhesive, a threaded screw, a sewn thread, and a fused coupling. The coupling member is waterproof and sweat-proof to enable use of the lighting assembly in wet conditions. The portable lighting assembly is removably attachable to objects such that the portable lighting assembly is capable of being detached from an object and re-attached to another object. When the coupling member is an adhesive, the adhesive is selected from a group consisting of silicone, polyurethane, rubber, synthetic rubber, hydrogel or a combination thereof.

In another embodiment of the present invention, a portable lighting assembly includes: a base having a front side and a rear side, wherein at least the front side is translucent; a lamp for generating light to pass through at least the translucent front side; a first power source; a switch for selectively electrically coupling the first power source to the lamp for illuminating the lamp; a first coupling member, connected to the rear side of the base; and a second coupling member, connectable to an object and removably connected to the first coupling member, for removably attaching the base to the object.

In a further embodiment of the present invention, a method includes: providing a portable lighting assembly including a base having a front side and a rear side wherein at least the front side is translucent, a lamp, a first power source, a switch electrically couplable to the first power source and to the lamp, and a coupling member connected to the base; removably attaching the base to an object using the coupling member; operating the switch for selectively electrically coupling the first power source to the lamp, thereby illuminating the lamp; generating light from the lamp; and passing the generated light through at least the translucent front side.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a rear view of the portable lighting assembly of the present invention and an embodiment of an attachment means of the present invention;

FIG. 2 is a side view of the portable lighting assembly of FIG. 1; and

FIG. 3 is a front view of the portable lighting assembly of FIG. 1.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

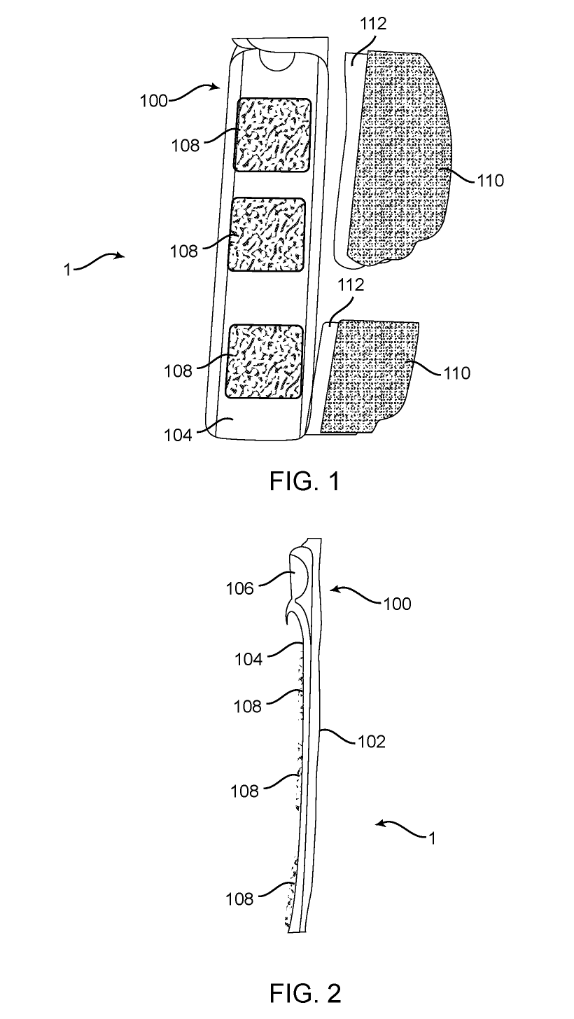

Referring to FIGS. 1-3, the portable lighting assembly 1 comprises a base 100, having a front side 102 and a rear side 104; a light (not shown) positioned under the front side 102; a battery (not shown); a switch 106; a first coupling member 108; and a second coupling member 110.

The base 100 may be made of silicone, rubber, plastic, fabric, metal, or other flexible or non-flexible material, or combination thereof, such that at least the front side 102 has a translucent portion. The translucent portion can be colored to enable colored light and may include shapes or patterns of a different opaqueness. A lining on the inside or the outside surface of the front side 102 or the rear side 104 can provide additional user comfort or additional structural integrity. For example, a cushioned lining would allow some contraction and expansion, providing additional user comfort and a more secure fit.

In the exemplar embodiment, the base 100 is made of flexible translucent silicone that is water and weather resistant and contains a less flexible lining in order to protect the internal components. The flexibility allows the portable lighting assembly 1 to be mounted and conformed to a variety of surfaces including curved surfaces. In addition, the user can bend the base 100 into desired configurations. For example, the base 100 can be twisted to provide 360-degree illumination. Waterproofing and weatherproofing allows the portable lighting assembly 1 to be used outdoors and in and around water and in any weather condition.

The light and battery are contained within the base 100, such that the light is visible through the translucent portion 104. The light may be an LED light or other light and of any color. The battery may be replaceable or non-replaceable, removable or non-removable, and rechargeable or non-rechargeable. It can be recharged by a charging cable via a port protected by a cover, by an exposed port, by induction, or other means.

Multiple lights can be connected to the battery in parallel or in series. A parallel circuit allows an individual light or connection to malfunction without disabling all the lights. In addition, a parallel circuit would allow a user to cut the portable lighting assembly 1 to a desired length.

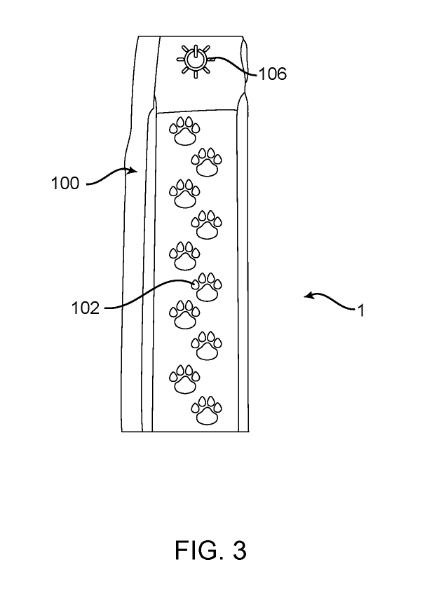

Referring to FIG. 3, a switch 108 is located on the front side 102. The switch 108 turns the light on and off. It may also adjust the light's color and intensity, as well as provide a strobe or flashing light functionality, including pre-programmed signals such as SOS. The switch 108 can be connected to a timer that automatically turns the light on or off. In the exemplar embodiment, the switch 108 is a push button contained within at a top end of the base 100.

Referring to FIGS. 1-2, the rear side 104 comprises a first coupling member 108. The first coupling member 108 may be a hook or loop fastener (e.g., Velcro), magnet, adhesive, threaded screw, or other means of coupling with the second coupling member 110. It is attached to the rear side 104 by means of adhesive, fusing, sewing, or other means of attaching the first coupling member 108 to the rear side 104.

In use, the second coupling member 110 is coupled to the first coupling member 108, again, by means of a hook or loop fastener, magnet, adhesive, or other means. In the exemplar embodiment, the first coupling member 108 is a micro hook fastener (see FIG. 1) and the second coupling member 110 is a corresponding micro loop fastener (not shown). An opposite side of the second coupling member 110 (see FIG. 1) is coupled to another surface (not shown) by means of adhesive. As shown in FIG. 1, the adhesive of the second coupling member 110 is initially covered with a removable film 112 and may be re-usable or re-adherable.

In another embodiment, the rear side 104 is also translucent and the front side 102 has a coupling member of the same or different type as the first coupling member 108 on the rear side 104. This allows the portable lighting assembly to be mounted on either side or both sides. It also enables the portable lighting assembly to be folded onto itself. For example, the first coupling member 108 can be a micro hook fastener and the coupling member on the front side 102 can be a micro loop fastener, enabling the portable lighting assembly to be rolled into a circle shape and secured by the fasteners on each side. This enables the portable lighting assembly to be detachably secured around a user's arm, loops, handles, poles, laces, such as shoelaces, or other object. It can be adjusted to provide a snug fit. The light can be illuminated between the fasteners or through translucent fasteners.

As mentioned above, in another embodiment, the base 100 could be provided with a re-adherable adhesive such that the portable lighting assembly could be easily removed and reattached to and from different objects, including clothing or directly on the body. In this embodiment, the re-adherable adhesive could be applied to the second coupling member, or the re-adherable adhesive could be applied to the first coupling member and the second coupling member could be eliminated and the lighting assembly could be directly attached to different objects via the first coupling member.

The adhesive in all embodiments described above can also be waterproof to enable use in wet conditions, including underwater. For example, it can be used by swimmers or divers. The adhesive could be comprised of silicone, polyurethane, rubber, synthetic rubber, or a hydrogel, for example, water-based or silicone based, or a combination thereof.

The lighting assembly of the present invention could be used for a number of purposes. As stated above, the lighting assembly of the present invention is reusable and re-adherable. Therefore, the uses of the present invention are unlimited. The portable lighting assembly can be used for safety, recreation, entertainment, decoration, or any other purpose where illumination is desired. It can be used by emergency medical technicians, law enforcement officers, military personnel, mechanics, construction workers, plumbers, electricians, or others who require specific areas to be illuminated in the course of their work. It can also be used by those requiring illumination for visibility or safety in dim or nighttime conditions such as nighttime jogging, roadside emergencies, and deep sea diving. Furthermore, the lighting assembly could be used at home and secured to one location, detached, and re-secured to a new location without damaging the object adhered to and without losing adherability.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes, which come within the meaning and range of equivalency of the claims, are to be embraced within their scope.

What is claimed is:

1. A portable lighting assembly comprising:
a base having a front side and a rear side, wherein at least the front side is translucent;
a lamp for generating light to pass through at least the translucent front side;
a first power source;
a switch for selectively electrically coupling the first power source to the lamp for illuminating the lamp; and
a coupling member, connected to the base, for removably attaching the base to an object.

2. The portable lighting assembly of claim 1, wherein the coupling member is an adhesive, the portable lighting assembly being removably attachable to objects such that the portable lighting assembly is capable of being detached from an object and re-attached to another object.

3. The portable lighting assembly of claim 2, wherein the adhesive is selected from a group consisting of silicone, polyurethane, rubber, synthetic rubber, hydrogel or a combination thereof.

4. The portable lighting assembly of claim 2, wherein the adhesive is water and sweat resistant.

5. The portable lighting assembly of claim 1, further comprising:
a lining mounted on a surface of at least one of the front side and the rear side for providing user comfort.

6. The portable lighting assembly of claim 1, wherein the base is composed of at least flexible translucent silicone that is water-resistant and weather-resistant and includes a lining to protect the lamp and the battery.

7. The portable lighting assembly of claim 1, wherein the lamp is selected from a light-emitting diode (LED), a fluorescent light, and an incandescent light.

8. The portable lighting assembly of claim 1, wherein the first power source is a battery.

9. The portable lighting assembly of claim 1, wherein the switch controls at least one of an intensity of the lamp, a color of the lamp, a strobing function of the lamp, and a flashing function of the lamp.

10. The portable lighting assembly of claim 1, further comprising a timer to automatically turn the lamp on or off.

11. The portable lighting assembly of claim 1, wherein the switch is a push button disposed at a top end of the base.

12. The portable lighting assembly of claim 1, wherein the object is selected from a portion of a body of a user, an article of clothing worn by the user, and a piece of equipment used by the user.

13. The portable lighting assembly of claim 1, wherein the coupling member is selected from a hook-or-loop fastener, a magnet, an adhesive, a threaded screw, a sewn thread, and a fused coupling.

14. A portable lighting assembly comprising:
a base having a front side and a rear side, wherein at least the front side is translucent;
a lamp for generating light to pass through at least the translucent front side;
a first power source;
a switch for selectively electrically coupling the first power source to the lamp for illuminating the lamp; and
a first coupling member, connected to the rear side of the base.

15. The portable lighting assembly of claim 14, wherein the first coupling member is an adhesive, the portable lighting assembly being removably attachable to objects such that the portable lighting assembly is capable of being detached from an object and re-attached to another object.

16. The portable lighting assembly of claim 15, wherein the adhesive is selected from a group consisting of silicone, polyurethane, rubber, synthetic rubber, hydrogel or a combination thereof.

17. The portable lighting assembly of claim 16, wherein the adhesive is water and sweat resistant.

18. The portable lighting assembly of claim 14, further comprising a second coupling member removably connected to the first coupling member and removably connectable to an object and for removably attaching the base to the object such that the portable lighting assembly is capable of being detached from an object and re-attached to another object.

19. The portable lighting assembly of claim 18, wherein the first and second coupling members are selected from a hook-and-loop fastener, a magnet, an adhesive, a threaded screw, a sewn thread, and a fused coupling.

20. A method comprising:
providing a portable lighting assembly including a base having a front side and a rear side wherein at least the front side is translucent, a lamp, a first power source, a switch electrically couplable to the first power source and to the lamp, and a coupling member connected to the base;
removably attaching the base to an object using the coupling member;
operating the switch for selectively electrically coupling the first power source to the lamp, thereby illuminating the lamp;
generating light from the lamp; and
passing the generated light through at least the translucent front side.
